(19) United States
(12) Patent Application Publication
(10) Pub. No.: US 2024/0343358 A1
(43) Pub. Date: Oct. 17, 2024

(54) FLOATING WIND TURBINE PLATFORM

(71) Applicant: Aker Offshore Wind Operating Company AS, Lysaker (NO)

(72) Inventors: Jorge Campos Antunes Ferrao, Oslo (NO); Simen Fodstad Stolen, Nesoddtangen (NO); Rolf Loken, Haslum (NO)

(73) Assignee: Aker Offshore Wind Operating Company AS, Lysaker (NO)

(21) Appl. No.: 18/293,693

(22) PCT Filed: Jul. 28, 2022
(86) PCT No.: PCT/NO2022/050183

§ 371 Date: Jan. 30, 2024

(30) Foreign Application Priority Data
Jul. 30, 2021 (GB) GB2110980.6

(51) Int. Cl. B63B 35/44; B63B 43/06

(52) U.S. Cl. CPC B63B 35/44; B63B 43/06; B63B 2035/446

(57) ABSTRACT

Described herein is a floating wind turbine platform comprising a hull, a wind turbine tower. The hull comprises a pontoon base and a first, second and third column integrally formed with the pontoon base, and the wind turbine tower is fixed to and extends upwardly from the first column. The pontoon base and the first, second and third columns are formed substantially of concrete.

The present invention relates to a floating wind turbine platform, for example a floating wind turbine platform to produce electric energy at offshore locations.

### BACKGROUND

Recently, there has been a surge in the production and use of wind turbines to provide electrical power. This surge has been driven among other things by an increasing awareness of the threats posed by anthropogenic climate change, and a subsequent interest in procuring energy in a climate conscious way.

Wind turbines may be positioned both on land, and offshore. For various reasons, offshore wind turbines are able to be built with higher capacity than those of their onshore counterparts, resulting in the offshore turbines ultimately producing a greater amount of electrical power. While this is desirable, the installation of offshore wind turbines can be complex, as a reliable platform or foundation is required, and the installation often must be performed within short time windows, and in some cases at great water depths.

After a certain water depth, it becomes no longer feasible to install an offshore wind turbine with a fixed foundation. One alternative is to install the wind turbine with a floating foundation, which may comprise a buoyant hull onto which the wind turbine may be mounted, and which may itself be anchored to the sea floor via cables, wires, chains, ropes, or the like.

Some hull designs are already in existence. Generally such hulls are made of multiple sections which are connected together—e.g. multiple metal sections which may be welded together, and/or multiple concrete sections which may be attached together. One benefit of using concrete as a material for the buoyant hull is that it may be cured into a variety of desirable shapes, thereby offering a level of versatility that metal cannot.

However, the use of concrete as a hull material also has its drawbacks, for example in that difficulties may arise when mounting a metal wind turbine tower thereto.

Publications which may be useful to understand the field of technology include WO 2016/205746 A1 and WO 2020/167137 A1.

There is a need for improved floating wind turbine platforms having a concrete hull that offers a stable platform for mounting a wind turbine thereto. The present disclosure has the objective to provide such improved platforms, or at least alternatives to the state of the art.

### SUMMARY

In an embodiment, there is provided a floating wind turbine platform comprising: a hull; a wind turbine tower; wherein the hull comprises a pontoon base and a first, second and third column integrally formed with the pontoon base, wherein the wind turbine tower is fixed to and extends upwardly from the first column, the pontoon base and the first, second and third columns being formed substantially of concrete.

In an embodiment, there is provided a method of construction of a floating wind turbine platform, comprising: forming a wind turbine hull comprising a pontoon base and integrally formed first, second and third columns substantially of concrete; positioning the wind turbine hull in a body of water and connecting a wind turbine tower to the first column thereof, so as to extend upwardly from the first column; locating the wind turbine hull with the connected wind turbine tower at an offshore location.

In an embodiment, there is provided a support member for connecting a wind turbine tower to a structure, comprising: a hollow elongate member comprising a lesser diameter end an a greater diameter end, the lesser diameter end comprising a wind turbine tower connection arrangement, and the greater diameter end comprising a structure connection arrangement; the hollow elongate member being formed substantially of metal.

The detailed description and appended claims outline further aspects and embodiments.

### BRIEF DESCRIPTION OF THE DRAWINGS

These and other characteristics will become clear from the following description of illustrative embodiments, given as non-restrictive examples, with reference to the attached drawings, in which:

FIG. 1 is a perspective view of a floating wind turbine platform according to an example.

FIG. 2 is a side view of the floating wind turbine platform shown in FIG. 1.

FIG. 3 is a schematic illustration of an elevation of a hull.

FIG. 4 is an orthographic illustration of a hull.

FIG. 5 is a schematic illustration of a hull comprising pre-tensioned cables or rods.

FIGS. 6A and 6B are sectional views of the interface between a hull and a turbine tower.

FIGS. 7A-C schematically illustrate a hull comprising a ballast arrangement.

FIGS. 8A-C schematically illustrate a further example of a hull comprising a ballast arrangement.

FIG. 9 schematically illustrates a fluid pump system for a hull.

### DETAILED DESCRIPTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

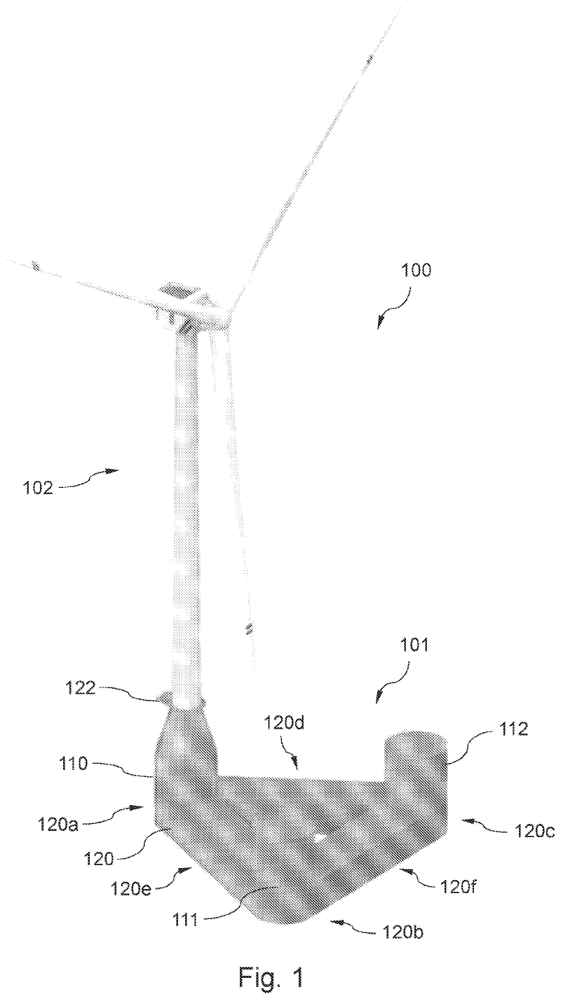

FIG. 1 illustrates a perspective view of a floating wind turbine platform 100 comprising a hull 101 and a wind turbine tower 102 comprising a nacelle and turbine blades. The skilled person will understand that the exact nature of the wind turbine tower 102 may differ in different situations, and is not limited to that illustrated. Viewed from above (i.e. in a plan view) the hull 101 has a triangular shape, comprising a triangular shaped pontoon base 120 having three corner parts 120a, 120b, 120c connected by three pontoon members 120d, 120e, 120f. On each corner part 120a-c is mounted a column, such that there exists first, second and third columns 110, 111, 112. Having three pontoon members 120d-f connected in a triangular formation provides a stable structure that is able to withstand higher external forces than would otherwise be possible, and allows each column 110, 111, 112 to be supported in two directions by the pontoon members 120d-f. Additionally, the triangular shape increases the water plane area, aiding buoyancy and assisting to allow the turbine platform 100 to achieve a very shallow draft that may be useful during construction, installation and/or return to shore for maintenance.

Each of the pontoon members 120d-f comprises a rectangular shaped cross-section along their longitudinal extension between the corner parts 120a-c, while each of the columns 110, 111, 112 has a circular cross section along its longitudinal extension, and may be in the form of a cylinder, or may be otherwise formed (e.g. the first column 110 may be otherwise formed) as will be described in further detail in the following paragraphs. The longitudinal extension of each of the pontoon members 120d-f is the length extending in the direction between the corner parts 120a-c thereof.

As can be seen in FIG. 1, the corner parts 120a-c of the hull 101 comprise rounded (e.g. filleted) external surfaces in this example (e.g. the corners are rounded such that no vertex is formed by the conjunction of the external sides of the pontoon members 120d-f. The corner parts 120a-c may comprise a rounded external surface of the same radius as the column 110, 111, 112 mounted on the respective corner part 120a-c. In such examples, part of the outer surface of a or the column(s) 110, 111, 112 may be aligned with the respective filleted corner part 120a-c, as is illustrated in FIG. 1. Such a configuration may produce a hull 101 that comprises a minimum of sharp edges, and may therefore have a shape that is easier to form/cure. Such a configuration may also more desirably and evenly distribute stress concentrations.

The hull 101 may be hollow, or comprise a hollow section. For example, at least one of the corner parts 120a-c, the pontoon members 120d-f and the columns 110, 111, 112 may be hollow. The hollow section may house an internal component of the hull 101, for example a ballast or storage tank, and/or may provide a gap in which cabling may be positioned (e.g. structural cabling, electrical cabling, telecommunications cabling or the like). In the case where a tank is provided inside the hull 110, an access port/hatch may be provided on the hull 101, providing access to the tank for cleaning/maintenance purposes. The tank may comprise at least one external connection (e.g. a fluid connection) to the external environment (e.g. a fluid conduit that extends through the material of the hull 101). Such an external connection may comprise a valve at an inlet/outlet thereof (e.g. a one-way valve) and may comprise a pump for the purposes of filling/emptying the tank. The inlet and/or outlet may be positioned on the hull 101 such that in all drafts of the hull 101, the inlet and/or outlet is in fluid contact with a body of water in which the floating wind turbine platform 100 is positioned.

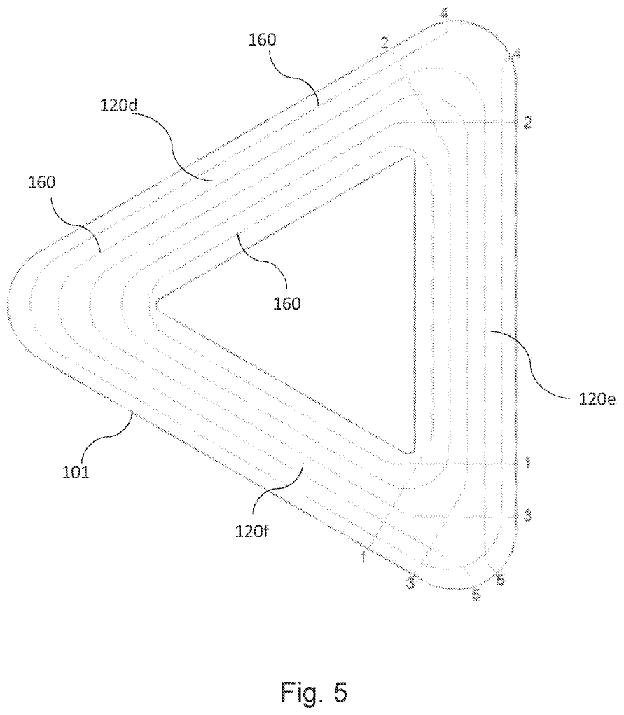

The hull 101 may comprise internal structural cabling or support rods. The cabling or rods may be tensioned. For example, the hull 101 may comprise metal rods or cables that extend along the length of each of the pontoon members 120d-f. In some cases, a support rod or cable extending along the length of one pontoon member 120d-f may connect to a rod extending along an adjacent pontoon member 120d-f at a corner part 120a-c. In some examples, a support rod or cable may connect at both ends to adjacent support rods or cables. In some other examples, a cable or rod may extend directly from one pontoon member 120d-f to one adjacent. In the case of the illustrated example, this may result in a triangular formation of support rods or cables extending through (along the longitudinal extension of) each of the pontoon members 120d-f, with each support rod or cable being attached to another at each end thereof, or comprising a single rod or cable extending in a loop. In FIG. 5 is illustrated an example of a hull 101 comprising various support rods or cables 160 extending therethrough. Here, the support rods or cables 160 may be pre-tensioned. In FIG. 5, various support cables/rods 160 extend through the pontoon members, parallel to the longitudinal axis of the pontoon member 120d-f and in a loop. Here, each of the cables/rods 160 is anchored to the concrete hull 101 at an outer surface thereof. However, one or more of the cables/rods 160 may be formed in a complete loop, with one end of each cable/rod 160 being anchored to the other end of that cable/rod 160. Alternatively, the cables/rods 160 can be anchored to the concrete hull 101 at an inner surface or at an internal location thereof.

Advantageously, the configuration shown in FIG. 5 or alternatives thereof can allow individual tensioning cables or rods to extend through several pontoon members and/or several corner parts without being anchored thereto. In this manner, anchoring points and anchoring arrangements may only be necessary at a reduced number of locations, for example can the anchoring of tension cables or rods be arranged in a single corner part or in a single pontoon member, or e.g. in two corner parts, as illustrated in FIG. 5. (While FIG. 5 shows anchoring in corner parts, it should be understood that the anchoring can, alternatively or additionally, be located in the pontoon members.) The use of a substantially triangular base may permit such an arrangement without experiencing excessive bend angles on the tensioning cables or rods.

It should be noted that in the examples illustrated, the pontoon base 120 made of concrete is sufficiently strong such that no other external support members are required (e.g. no upper support beams or braces are required to connect the top of the columns together).

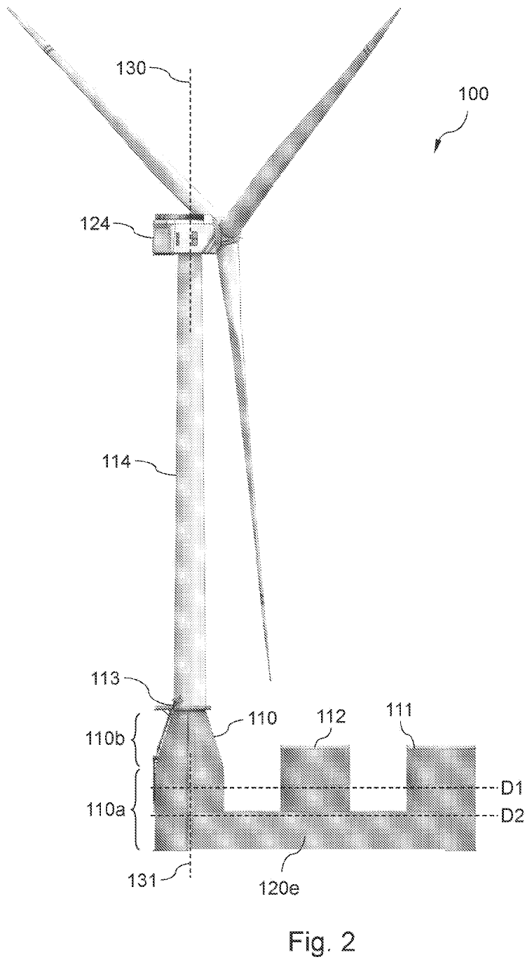

At an interface 113 (see FIG. 2) between the hull 101 and the wind turbine tower 102 is an access platform 122. The access platform 122 may facilitate a maintenance or construction worker or personnel to access the wind turbine tower 102, and may assist in providing access to both the outside and inside of the wind turbine tower 102 (e.g. via a door, hatch or the like). The access platform may additionally assist during the installation of the wind turbine tower 102 on the hull 101. Although not illustrated in detail in FIG. 1, there may be a ladder, or similar apparatus, located on the first column 110 to assist in providing access to the access platform 122.

Visible in FIG. 1, but most clearly illustrated in FIG. 2, is the construction of the first column 110 in two parts; in this example, specifically in a lower first part 110a and an upper second part 110b. The lower first part 110a is substantially cylindrical in shape. In FIG. 2, the lower first part 110a is illustrated as being shorter than the cylindrical sections of the second and third columns 111, 112, although it should be understood that this may not necessarily be the case. In some examples, the first part 110a may be the same height as the second and third columns 111, 112 (or at least one of the second and third columns, in the case where the second and third columns 111, 112 have different heights), or may be taller than one or both of the second and third columns 111, 112.

Here, the upper second part 110b is in the form of a frustum cone, and is integrally formed with the lower first part 110a to form the first column 110 such that the diameter of the first column 110 decreases towards the interface 113 with the wind turbine tower 102. As such, the base of the second part 110b is of the same diameter as the cylindrical first part 110a. As both are made of concrete in this example the first part 110a and the second part 110b may be integrally formed through, for example, the use of a slip moulding process. The truncated top of the second part 110b naturally has a smaller diameter than the base, and may have the same, or a similar diameter to the base of the wind turbine tower 102. In some examples, the radius of the truncated top 110b may be slightly larger than the diameter of the base of the wind turbine tower, and this may facilitate a stable base on which to mount the wind turbine tower 102.

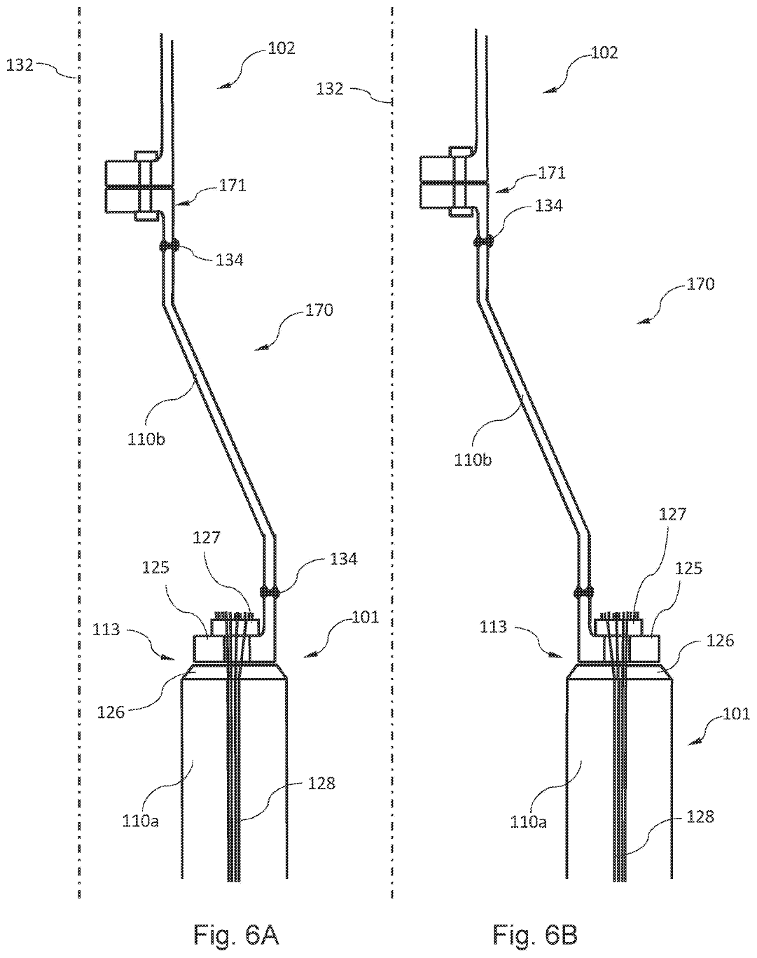

Having a second part 110b in the shape of a frustum cone may assist to transition the diameter of the first column 110 from that required for the hull 101 (e.g. for structural and/or buoyancy reasons) to that required to mount the wind turbine tower 102 thereon. As such, the frustoconical second part 110b may assist to provide a stable base for attachment of the wind turbine tower 102 thereon. Although not illustrated, the second part 110b, and optionally also the first part 110a, may be formed with post-tension cables therein, which may be held in tension using a cable head, and which may be used to anchor the wind turbine tower 102 in place on the first column 110 (see also FIGS. 6A and 6B for a description of mounting via post-tension cables).

As illustrated in FIGS. 1 and 2, the wind turbine tower 102 comprises a tower 114 that is mounted on the first column 110 at the interface 113 thereof. The tower 114 comprises a centre axis 130. Aligned with the centre axis 130 at the top of the tower 114 may be a centre axis and/or centre of gravity of the nacelle 124. At the bottom of the tower 114, the centre axis 130 may be aligned with a centre axis 131 of the first column 110. Such alignment of the centre axis of the tower 114 and the first column 110 may provide a stable mounting relationship between the tower 114 and the first column 110. As such, the tower 114 may extend upwardly from the first column 110 with its centre axis 130 aligned with that of the first column 110.

In some examples, the centre axis 130 of the tower 114 may not be aligned with the centre axis 131 of the first column 110, but may be parallel, or substantially parallel thereto. For example, the centre axis of the tower 114 may be displaced towards an upwardly extending centre axis (not shown) of the hull 102, and therefore may be translationally (e.g. horizontally) displaced relative to the centre axis 131 of the first column 110. Translational displacement of the centre axis 130 of the tower 114 relative to the centre axis 131 of the first column 110 may assist to provide stability to the floating wind turbine platform 100, for example by shifting the centre of gravity of the entire floating wind turbine platform 100 towards a more central location.

Additionally illustrated in FIG. 2 are a first and a second draft D1, D2 of the platform 101, indicated by a broken line. The drafts D1, D2 may correspond to the water level relative to the floating hull 101 when the floating wind turbine platform 100 is located in a body of water. In the lower draft D1, the entire pontoon base 120 is submerged below the waterline, and only part of the first, second and third columns 110, 111, 112 protrudes from the waterline (the first column 110 having the wind turbine tower 102 extending upwardly therefrom).

In contrast, in the upper draft D2, at least the top surface of the pontoon base 120 (e.g. the top flat surface of the pontoon members 120d-f, and the top part of the corner parts 120a-c) additionally protrudes above the water level, as does the first part of the first column 110a, and the entirety of the first, second and third columns 110, 111, 112 located above the pontoon base 120.

In the lower draft D1, the centre of gravity of the floating wind turbine platform 100 may be closer to the waterline, which may result in a more stable configuration of the wind turbine platform 100. This may be useful when the wind turbine platform 100 is in operation (e.g. located in an offshore location and operable to produce electrical energy). In the first draft, the wind turbine platform 100 may be less affected by the impact of waves on the hull 101 and/or turbulent wind on the turbine tower 102.

In the upper draft D2, the centre of gravity of the floating wind turbine platform 100 may be higher, and (as previously described) more of the hull may protrude above the waterline. In particular, the top surface of the pontoon base 120 may protrude above the waterline, providing personnel access thereto (e.g. maintenance or construction personnel). Equally such personnel may have access to the full height of the columns 110, 111, 112 (e.g. the full height of the columns 110, 111, 112 above the pontoon base 120). Such access may allow repairs to be made. In the case where the pontoon base 120 comprises ballast tanks therein, access to the ballast tanks may be facilitated by having the floating wind turbine platform 100 in the upper draft D2. The pontoon base 120 may comprise a hatch, door, access panel or the like on the top surface thereof (e.g. the upper flat surface of the pontoon members 120d-f) to permit personnel access to the interior of the pontoon base (e.g. to ballast tanks, electrical or structural cabling, or the like) that may be contained therein.

In addition, in the second draft D2, the height of the columns 110, 111, 112 above the waterline is higher than in the first draft D1. This may provide benefits during construction of the floating wind turbine platform 100. For example, in the second draft D2, the interface 113 between the hull 101 and the wind turbine tower 102 has a greater elevation, which may be preferable in situations where the turbine tower 102 is being installed onto the hull 101 at a quayside, as this may provide easier access to equipment and machinery such as cranes on the shore, or on a vessel. Further, the hull 101 is able to float in shallower water without running aground, which may be preferable to provide access to a quayside, where the water may be particularly shallow.

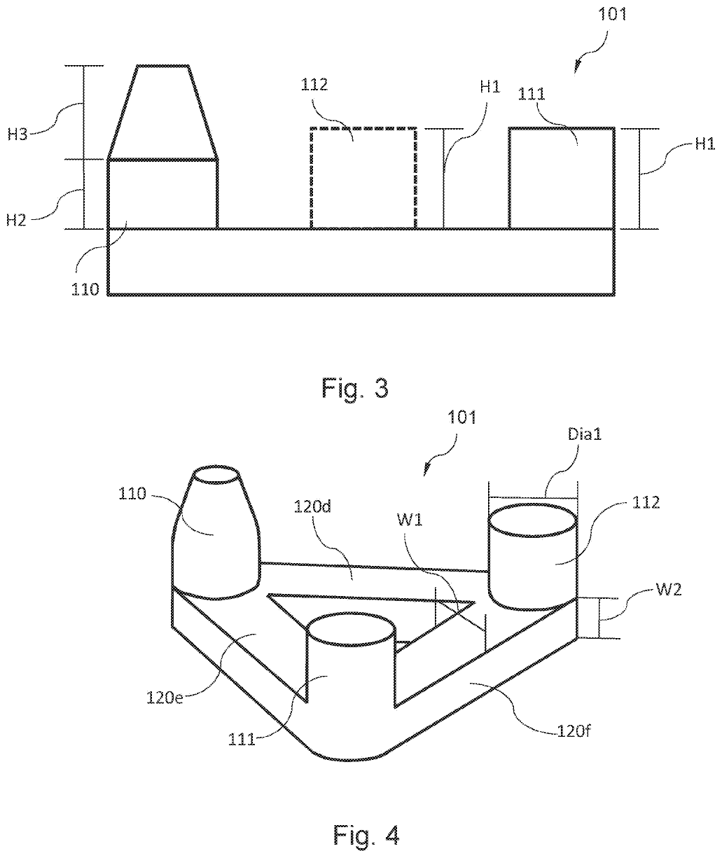

Illustrated in FIG. 3 is a schematic diagram of a hull 101, including some schematically illustrated relative dimensions. Here, the height of the second and third columns 111, 112 is indicated schematically as being H1. The first column 110, as previously described, comprise a first part 110a and a second part 110b. Here, the height of the first part is illustrated as being H2, and the height of the second part is illustrated as H3, meaning that the overall height of the first column 110 is equal to the sum of H2 and H3.

In any of the embodiments claimed or described herein, the design of the hull 101 may be such that H1 is equal to H2 (i.e. that the height of the first column 110 and the second/third column 111, 112 have a ratio of 1), or H1 may be greater than H2, as in FIG. 3. Similarly, several values of H3 may be possible. In the example of FIG. 3, H3 is greater than H2, although in some other examples, H3 may be equal or lesser in value than H2. In any of the embodiments claimed or described herein, the sum of H2 and H3 may be greater than H1, or optionally the sum of H2 and H3 may be equal to H1. For example, by arranging H2<H3 and (H2+H3)>H1 as illustrated in FIG. 3 can provide manufacturing advantages in that it can provide simplified integration of the tower 114.

A further schematic illustration of the hull 101 of the floating wind turbine platform 100 is shown in FIG. 4. Here, the horizontal width W1 and vertical width W2 (which may also be referred to as the height) of each pontoon member 120d-f is indicated. Various ratios between the horizontal and vertical widths W1, W2 of the pontoon members 120d-f may be possible. In this example, the horizontal width W1 is illustrated as being larger than the vertical width W2 although in some examples the horizontal width W1 and the vertical width W2 may be equal or substantially equal, and in some other examples, the vertical width W2 may be greater than the horizontal width W1.

As illustrated in FIG. 4, the ratio of the horizontal width W1 to the vertical width W2 may be greater than 1, for example greater than 1.2, greater than 1.4, or about 1.4 (i.e. the horizontal width W1 is greater than the vertical width W2 by some factor). In some other examples, the ratio between the horizontal width W1 and the vertical width W2 may be approximately 1, or may be less than 1.

Also illustrated in FIG. 4 is the diameter Dia1 of the third column 112. In this example, the diameter Dia1 of the third column 112 is equal to that of the first and second columns 110, 111. However, it should be noted there may be no need for the diameter of the columns 110, 111, 112 to be equal, and it may be possible to have designs of the hull 101 where the columns 110, 111, 112 have different diameters.

Various designs of hull 101 may be possible in which the ratio of the diameter of the columns 110, 111, 112 is changed relative to the horizontal width W1 of the pontoon members 120d-f. In this example the width W1 of the pontoon members 120d-f is larger than the diameter Dia1 of the columns. For example, the ratio of W1 to D1 may be about 1.2. Other ratios of D1 to W1 may be possible, for example any ratio between 1 and 1.4, more preferably 1.1 to 1.3, or about 1.2 as previously mentioned.

In some other examples, the ratio of D1 to W1 may be between 1 and 1.4, more preferably 1.1 and 1.3, or about 1.2. In such cases, the diameter Dia1 of the columns 110, 111, 112 would be greater than the width of the pontoon members W1.

FIGS. 6A and 6B illustrate an example of a wind turbine platform 100. Shown is a sectional view of a hull 101 (in particular, the first column 110 thereof) and a turbine tower 102 at the interface 113 therebetween—for clarity a centre line 132 is indicatively shown, which is the centre line of the first column 110, and in some examples may be aligned with the centre line 130 of the wind turbine tower 102. In this example, the lower first part 110a of the centre column 110 is made out of concrete, while the upper second part 110b is made out of a different material, which may be a metal or metal alloy such as steel.

In this example, the lower first part 110a is integrally formed with the rest of the hull 101, while the upper second part 110b is fastened thereto. As described in relation to the previous examples, the turbine tower 102 is connected to the upper second part 110b, which forms a support member 170 for connecting the wind turbine tower 102 to the first part 110a and thus to the platform 100. Having a frustoconically shaped upper part 110b and a cylindrically shaped lower part 110a may permit the hull 101 to be constructed in a more simplified manner. For example, the shape of the lower part 110a is now a simple cylinder, which may be easily formed from concrete. For example the concrete cylinder of the lower part 110a may be formed by a slip moulding process using a relatively simple slip-forming jig (owing to a cylinder's constant cross-section). The upper part 110b, has a decreasing cross-section which, while also possible to form using a slip-forming jig, may require a more complex construction.

It is evident from both FIGS. 6A and 6B that both the first part 110a and the second part 110b are hollow, as is the tower of the wind turbine tower 102. The wind turbine tower 102 is illustrated as being attached to the second part 110b by a bolted connection in this example, and the second part 110b comprise a flange 171 for that purpose. The turbine tower 102 comprises a corresponding flange part or equivalent, for interfacing with flange 171. However, it should be understood that any appropriate connection would be possible, for example a welded connection.

In order to attach the second part 110b (which in this example is made out of metal) to the concrete first part 110a, a different connection to that between the second part 110b and the turbine tower 102 may be required. In the examples of FIGS. 6A and 6B, the concrete first part 110a has been formed with a number of post-tension cables 128 therein. The base of the second part 110b comprises a flange 125 with an aperture therein, through which the post-tension cables 128 may be threaded (e.g. a top part of the post-tension cables 128 may be threaded). The post-tension cables 128 are then held in place by a cable head 127, which in this example is in contact with the flange 125 (and in this example sits directly on top thereof). The cable head 127 may anchor the post-tension cables 128 in place and maintain a degree of tension therein. In the example of FIGS. 6A and 6B, the cable head 127 anchors the post-tension cables to the first part 110a. As the post-tension cables 128 are threaded through the flange 125 of the second part 110b, the cable head 127 may additionally assist to hold the second part 110b in place relative to the first part 110a.

Located between the flange 125 at the base of the second part 110b is a grout layer 126. This grout layer 126 is present in both FIGS. 6A and 6B, and may serve as a transition layer between the concrete lower part 110a and the metal upper part 110b. In particular, the grout layer 126 may be used to account for any differences in width between the flange 125 and the first part 110a. In this example, the lower part 110a has a larger width (e.g. a larger radial width) than the flange 125, and the grout layer 126 permits a smooth transition therebetween, without the need for any stepped sections.

Further illustrated is a transition weld 134. The transition weld may assist in the construction of the wind turbine platform 100 by permitting a cone section to be formed, and then an upper and lower connection arrangement to be connected to the cone section as desired (e.g. a flanged section, or the like).

In both instances, the wind turbine tower 102 is attached to the upper second part 110b internally at an inwardly extending flange (i.e. extending from an external surface towards the centreline 132). This may assist to shield the connection components (e.g. the flange and associated bolt or fastening members) from corrosion due to contact with saltwater (e.g. seawater), rain, wind etc. . . .

In FIG. 6A, the cable head 127 is equally located internally, and the flange 125 extends inwardly (e.g. radially inwardly) of the second part 110b. Again, this may assist to protect the cable head 127 and the top of the post-tension cables 128 from corrosion due to the weather and contact with surrounding saltwater (e.g. seawater).

In FIG. 6B, the flange 125 can be seen located externally of the second part 110b (e.g. extending radially outwardly from the second part 110b). Such a design may be more useful in scenarios where the dimensions of the second part 110b are such that internal access is restricted, thereby resulting in increased difficulty in construction internally. In such cases, the configuration of FIG. 6B may be preferable. In such cases, further means of protecting the cable head 127 from the weather and saltwater may be deployed, such as a plastic or epoxy coating, cover or cap.

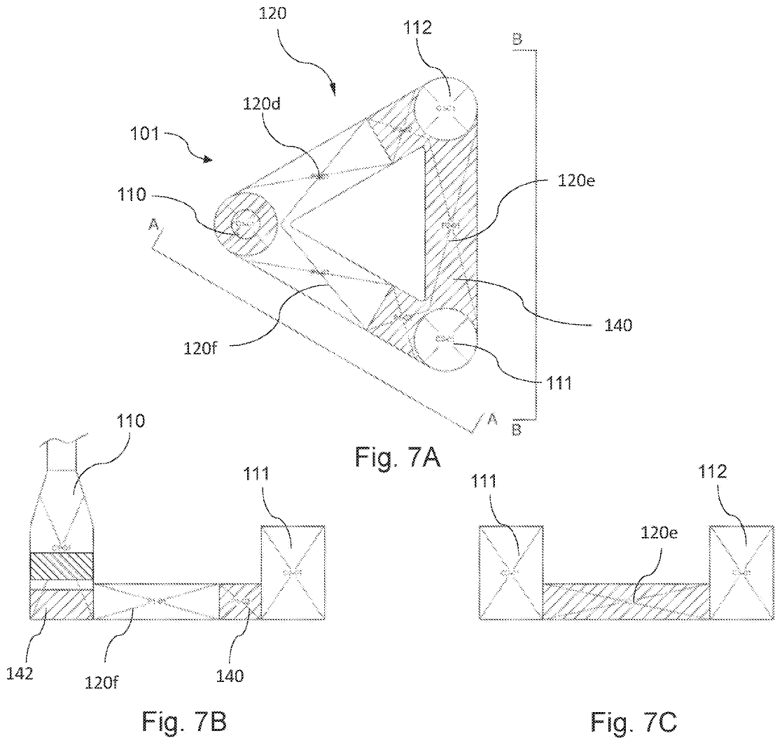

FIGS. 7A-C and 8A-C illustrate two examples of a hull 101 comprising a ballast arrangement therein. The ballast arrangement may be in the form of a ballast compartment or a number of ballast compartments contained within the hull 101 (e.g. within a hollow section of the hull 101). Each ballast compartment may be in the form of a void within the hull 101. The ballast compartments may comprise a ballast tank configured to hold a liquid such as freshwater or seawater, or may be configured to hold a solid ballast material which may be removed and inserted as necessary. In some examples, a ballast compartment, or the ballast compartments, may comprise a plurality of ballast tanks therein.

FIG. 7A illustrates a plan view of a hull 101, illustrating a triangular-shaped pontoon base 120 and a first, second and third column located at each corner thereof, as has been previously described. FIG. 7B illustrates an elevation view of the hull 101 from the viewpoint A-A, while FIG. 7C is an elevation view of the hull 101 from the viewpoint B-B.

In this example, a first ballast compartment 140 is located along the entire length of the pontoon member 120e, located between the second and third columns 111, 112, while part of pontoon members 120d, 120f also comprise the first ballast compartment 140. As the pontoon base 120 is in the form of a triangle, the first ballast compartment 140 may be considered to be located along the entire length of the pontoon member 120e oppositely disposed from the first column 110. In this example, the section of the first and third pontoon members 120d, 120f that may be considered to be adjacently disposed to the second pontoon member 120e (and to the first column 110) comprise part of the ballast compartment 140. The ballast compartment 140 may extend part way along the first and third pontoon members 120d, 120f, for example half way along, two-thirds of the way along, one-third of the way along, one-quarter of the way along, or the like. The ballast compartment 140 may be one single compartment (e.g. containing one continuous void for placement of a ballast material or liquid), or may comprise multiple compartments and/or voids, for example one compartment/void in the second pontoon member 120e, and one compartment in each of the first and the third pontoon members 120d, 120f.

The first ballast compartment 140 may be a void in one or more pontoon members 120d-f, and then a ballast tank may be set into the pontoon members 120d-f. Alternatively the ballast tank may be formed by the material of the pontoon members 120d-f themselves (e.g. a sealed void within the pontoon members), meaning that no separate ballast tank is required to be formed into the pontoon members 120d-f. In some examples, the pontoon members 120d-f may comprise a bulkhead or multiple bulkheads. The or each bulkhead may define a boundary of the ballast compartment. A bulkhead may be located, for example, at the centre of the opposite pontoon member 120e, and may be longitudinally moveable therealong to vary the volume of the first ballast compartment 140 on either side of the bulkhead. In the case where the first ballast compartment 140 is configurable to contain a liquid such as water, the bulkhead may be able to be pressed into the liquid volume in the ballast compartment, so as to remove any residual gas therein, thereby removing any liquid/gas boundary and ridding the ballast compartment of unwanted surface effects due to motion of the hull 101.

In addition, the bottom of the first column 110 comprises a second ballast compartment 142. The second ballast compartment 142 may be in the form of a base unit 142, which may be incorporated into the first column 110, or connectable thereto. In some examples, the bottom of the first column 110 (as illustrated in FIGS. 7A to C) including the second ballast compartment 142 may be considered to form part of the pontoon base 120. The second ballast compartment 142 may be formed in the base of the first column 101, and may not extend higher than the uppermost surface of pontoon base 120. The intersection between the pontoon member 120d-f and the column 110 may conveniently form, or assist to form, a compartment at the base of the column 110 in which the ballast compartment 142 may be located.

As with the ballast compartment 140, the second ballast compartment 142 may comprise a ballast tank, or the material of the column 110 may define the ballast compartment. Where the second ballast compartment is a base unit 142, the base unit may be or define a ballast tank, connectable to the first column 110. In some examples, the column 110, the second ballast compartment 142 may comprise a bulkhead therein, which also may be used to remove or reduce surface effects.

Illustrated in FIG. 7B, the second ballast compartment 142 may comprise an upper and a lower portion. The upper portion may be located above the height of the uppermost surface of the pontoon member 120d-f, whereas the lower portion may be located below the height of the uppermost surface of the pontoon member 120d-f, as is illustrated. The upper and lower portions may be connected and/or in fluid communication, or may be separate from one another. The upper portion may comprise an upper ballast tank, whereas the lower portion may comprise a lower ballast tank. In some examples, the upper and lower portions may comprise a single ballast tank spanning both portions.

The second ballast compartment 142 may be in fluid communication with the first ballast compartment 140, for example via a ballast liquid transfer arrangement. For example, tubing or piping may extend in the hull 101 between the first and second ballast compartments 140, 142, which may enable a user to transfer ballast liquid between the first and second ballast compartments 140, 142, thereby enabling simple and quick redistribution of weight of the hull 101.

This ballast arrangement may provide for stability during operation, as it may enable the hull 101 to be weighted so as to offset the weight of the wind turbine tower 102 by optionally providing a counterweight at the opposite end of the hull 101.

The example of 8A-C provides a different configuration of a ballast arrangement. As in the previous example the first column 110 comprises a second ballast compartment 142, which will not be described further.

In this example, the first ballast compartment 140 is located along the entire length of the pontoon member 120e (as in previous examples), located between the second and third columns 111, 112. In contrast to the previous example, the first ballast compartment 140 is contained within the pontoon member 120e and does not extend into adjacent pontoon members 120d, 120f. However, in this example, the second and third columns 111, 112 also contain ballast compartments, which may be in the form of base units as previously described. The ballast compartment of the second and third columns 111, 112 may form part of the first ballast compartment 140, or they may be separate ballast compartments (e.g. in the form of base units), self-contained within each column 111, 112.

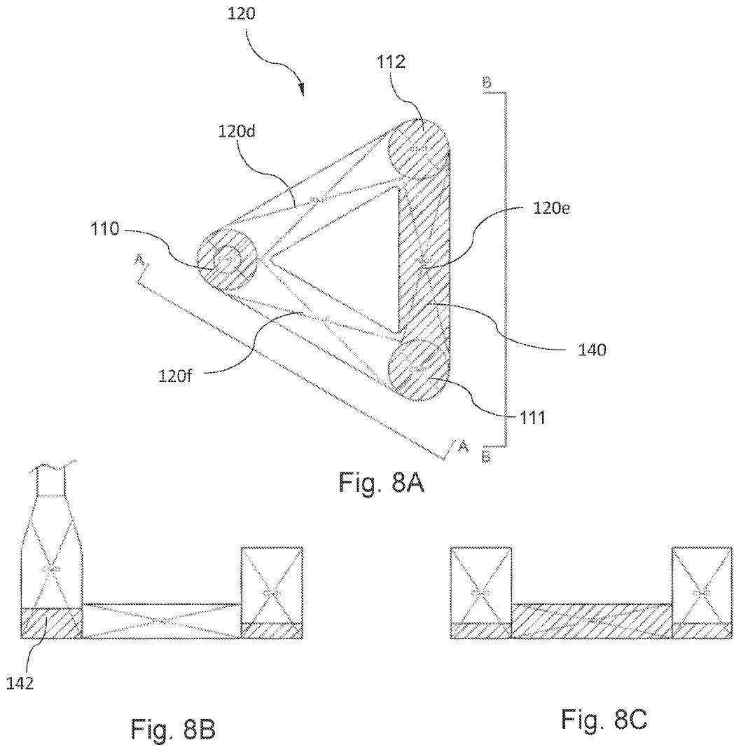

As is best illustrated in FIGS. 8B and 8C, the ballast compartment of the second and third columns 111, 112 may be shallower than that in the pontoon member 120e, and even than that of the first column 110. In some examples, the ballast compartment of the second and third columns 111, 112 may hold a solid ballast material, while the pontoon member 120e may hold a liquid ballast material (or vice versa). Although illustrated as being shallower than the ballast compartments of both the pontoon member 120e and the first column 110, in some examples it may be possible that the ballast compartment is deeper than one or both of the aforementioned.

The configuration of ballast arrangement of FIGS. 8A-C may provide an alternative weight distribution to that previously described in FIGS. 7A-C.

In any of the embodiments claimed or described herein, the pontoon member 120e which is located opposite the tower 102 may be configured to hold more liquid ballast than the first column 110 or the corner part 120a associated with the first column 110. Advantageously, the pontoon member 120e may be configured to hold more liquid ballast than the first column 110 or corner part 120a by a factor of two, three or four (i.e., more than double, more than three times or more than four times the liquid ballast capacity of the first column 110 or corner part 120a).

In any of the embodiments claimed or described herein, each of the two pontoon members 120d,f extending from the corner part 120a associated with the first column 110 and the tower 102 may be configured to hold more liquid ballast in a distal half of the respective pontoon member 120d,f than in the half of the pontoon member 120d,f which is proximal to and connects to the corner part 120a. (See, for example, FIG. 7A.) This can, for example, be realised by arranging liquid ballast tanks in a part of the pontoon member 120d which is closer to column 112 than to column 110 (and similarly for pontoon member 120f).

In both the ballast arrangements of FIGS. 7A-C and 8A-C, it may be possible to vary the ballast weight provided by each ballast compartment, thereby enabling a substantial degree of control over the weight distribution, centre of gravity and overall weight of the wind turbine platform 100. For example, a lighter platform may be useful during installation and maintenance. Depending on the stage of installation (e.g. whether only the turbine tower is mounted on the hull 101, or both the tower and the nacelle with blades), variation of the centre of gravity of the hull 101 may be a desirable feature. Variation of the weight and/or the centre of gravity of the hull 101 may provide easier access and/or improved stability of the hull 101 and the wind turbine platform 100 overall.

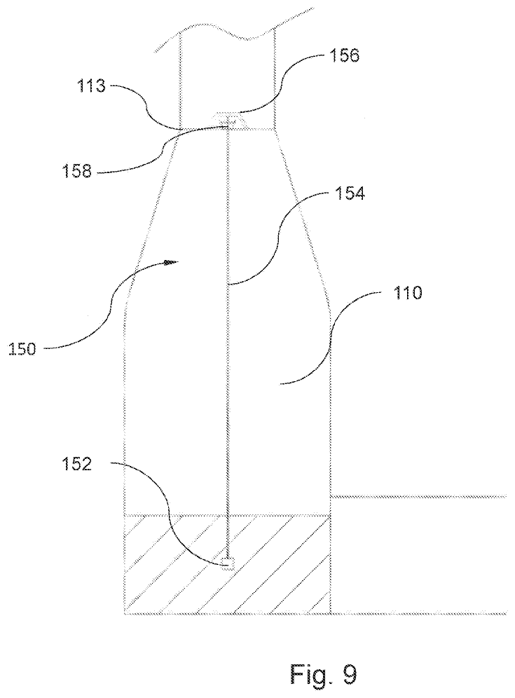

Illustrated in FIG. 9 is an example of a fluid pump system 150. In this example, the fluid pump system 150 is located inside the first column 110, although the skilled reader will understand that the fluid pump system 150 may be located in another part of the hull 101, for example in the second column 111 or the third column 112.

The pump system 150 comprises a submersible pump 152 suspended inside the first column 110 via a hoist arrangement 154. The pump 152 has a free hanging configuration. In this example, the hoist arrangement 154 is anchored in place at the interface 113 between the turbine tower 102 and the first column 110, although other anchoring locations may be possible. The hoist arrangement 154 is shown as being anchored to the column (here, the first column 110), although in other examples the hoist arrangement 154 may be anchored to the turbine tower 102.

The hoist arrangement 154 comprises an umbilical extending between the point at which the hoist arrangement 154 is anchored to the submersible pump 152. The umbilical may comprise electrical cabling, support cabling and/or piping, and thereby may be used to power and support the weight of the pump 152, as well as power the pump and transport fluid to and/or from the first column 110.

The hoist system may comprise a winch, or a connection point to a winch (not illustrated), which may enable raising and lowering of the pump 152 within the first column 110. This may be useful for installing the pump 152 at a desired depth, and for retrieving the pump 152, should removal, replacement or repair thereof be necessary.

Although a submersible pump is described in relation to this example, it may alternatively be possible to use a semi-submersible pump.

The hoist arrangement 154 may be supported by a platform and/or bracket/structure 156 located in the column (or in the turbine tower 102).

In addition the column comprises a fluid opening 158. In this example, the fluid opening 158 is located at the interface 113 between the column 110 and the turbine tower 102, thereby avoiding the need to create an opening in the turbine tower 102. However, in some other examples, the fluid opening 158 may be located in the turbine tower 102.

The fluid opening 158 may permit fluid to be removed from the column 110 via the fluid pump system 150. The fluid pump 152 may be used to pump fluid from the column 110, up the umbilical 154 and out of the fluid opening 158. In some examples, a fluid supply may be positioned at the fluid opening, and fluid may be able to be provided to the column 110 via the fluid opening 158. The fluid opening 158 may be configurable to be watertight (e.g. may comprise a hatch, covering, or the like) when not in use.

The umbilical of the hoist arrangement 154 may permit fluid communication between the fluid opening 158 and a ballast compartment in the column 110. As such, the fluid pump arrangement 150 may be used to remove and/or add ballast water to the ballast compartment. Additionally or alternatively, the fluid pump arrangement 150 may permit the removal of bilge water from inside the column 110 (e.g. water ingress into the column as a result of porosity of the column 110), and the pump 152 may be positioned appropriately in the column 110 so as to access bilge water inside the column 110.

Over time, as the hull 101 remains positioned in an offshore location, an increasing amount of marine growth may accumulate on the hull 101. The marine growth may have the effect of increasing the weight of the hull 101, thereby lowering the draft of the hull. In order to counteract this additional weight, the pump system 150 may be used to reduce the weight of the hull 101, thereby holding the wind turbine platform 100 at a constant draft throughout its use.

Having the illustrated configuration of a pump 152 that hangs freely from an anchor point at the top of the column 110 may permit a simpler design of both column 110 and pump system 150, as it minimises metal (e.g. steel) attachments to the concrete column (for example, as compared to installing the pump system 150 in the wall of the column 110), and the need for pipework extending through the concrete. The existing interface 113 between the column 110 and the tower 102 may facilitate the installation of a structure 156 for the pump system 150, and may provide metal anchor points to which the structure 156 may be connected.

According to embodiments described herein, a floating wind turbine platform is provided which enables efficient construction while ensuring structural strength and reliability required for long service life and operation in harsh operating conditions. In embodiments, the platform may further be designed to allow de-ballasting for easier maintenance and/or repairs.

The invention is not limited by the embodiments described above; reference should be had to the appended claims.

1. A floating wind turbine platform comprising:
a hull;
a wind turbine tower);
wherein the hull comprises a pontoon base and a first, second and third column integrally formed with the pontoon base,
wherein the wind turbine tower is fixed to and extends upwardly from the first column,
the pontoon base and the first, second and third columns being formed substantially of concrete.

2. The floating wind turbine platform (100) of claim 1, wherein the pontoon base is substantially triangular and wherein the first, second and third columns are arranged at respective corner parts of the base.

3. The floating wind turbine platform of claim 1, wherein the base comprises three substantially straight, elongate pontoon members extending between the corner parts.

4. The floating wind turbine platform of claim 3, wherein each of the elongate pontoon members comprises tensioned cabling extending therethrough and parallel to the longitudinal axis thereof.

5. The floating wind turbine platform of claim 1, wherein the wind turbine tower extends upwardly from the first column with a centre axis of the wind turbine tower coinciding with, or being parallel with and spaced from, a vertical centre axis of the first column.

6. The floating wind turbine platform of claim 1, wherein the first, second and third column are structurally connected only via the pontoon members, for example wherein the first, second and third column have no load-bearing connection between them above a design operational draft.

7. The floating wind turbine platform of claim 1, wherein the first, second and third columns have a cylindrical shape.

8. The floating wind turbine platform of claim 1, wherein the first column has a first part having a constant cross-sectional area along a vertical axis, and a second part having a reducing cross-sectional area along the vertical axis.

9. The floating wind turbine platform of claim 8, wherein the second part is frustoconical.

10. The floating wind turbine platform of claim 8, wherein the first part extends from a base of the platform to a level above a design operational draft.

11.-22. (canceled)

23. A method of construction of a floating wind turbine platform, comprising:
forming a wind turbine hull comprising a pontoon base and integrally formed first, second and third columns substantially of concrete;
positioning the wind turbine hull in a body of water and connecting a wind turbine tower to the first column thereof, so as to extend upwardly from the first column;
locating the wind turbine hull with the connected wind turbine tower at an offshore location.

24. The method of claim 23, wherein the body of water is at a quayside and is relatively shallower than the water of the offshore location, and the step of connecting a wind turbine tower to the first column is carried out with the hull at an upper draft and the step of locating the wind turbine hull at the offshore location comprises bringing the hull to a lower, operational draft.

25. A support member for connecting a wind turbine tower to a structure, comprising:
a hollow elongate member comprising a lesser diameter end and a greater diameter end, the lesser diameter end comprising a wind turbine tower connection arrangement, and the greater diameter end comprising a structure connection arrangement;
the hollow elongate member being formed substantially of metal.

26. The support member of claim 25, wherein the hollow elongate member is frustoconical and/or comprises a frustoconical portion, for example wherein the hollow elongate member comprises two substantially cylindrical portions forming the greater diameter end and lesser diameter ends, respectively, and a frustoconical portion therebetween.

27. The support member of claim 25, wherein the structure connection arrangement comprises an inward-facing flange or an outward-facing flange.

28. The support member of claim 27, wherein the inward-facing or outward-facing flange is configured to support a cable head having post-tension cables anchored therein.

29. A concrete floating wind turbine platform having at least one column integrally formed with a pontoon base and a wind turbine tower fixed to the at least one column via a support member according to claim 25.

30. The concrete floating wind turbine platform of claim 29, wherein the support member is fixed to the column via an inward-facing or an outward-facing flange by a cable head and post-tension cables or rods anchored at the greater diameter end.

31. The concrete floating wind turbine platform of claim 30, wherein the post-tension cables extend substantially vertically into the column.

32. The concrete floating wind turbine platform of claim 29, wherein the support member engages the at least one column via a grout layer.

33-40. (canceled)
